(19) United States
(12) Patent Application Publication
(10) Pub. No.: US 2016/0055447 A1
(43) Pub. Date: Feb. 25, 2016

(54) OPEN ENDED SHELVING UNIT WITH RFID FUNCTIONALITY

(71) Applicant: PROMEGA CORPORATION, MADISON, WI (US)

(72) Inventors: MARK SEHMER, STOUGHTON, WI (US); BRIAN GEORGE, BRODHEAD, WI (US); JOE PLESHEK, CAMBRIDGE, WI (US); JASON ROSEMURGY, MADISON, WI (US); TRAVIS PHILLIPS, STOUGHTON, WI (US)

(21) Appl. No.: 14/463,003

(22) Filed: Aug. 19, 2014

(51) Int. Cl. G06Q 10/08; G06K 7/10; A47F 5/01; B62B 3/00; A47F 10/00; A47F 5/00

(52) U.S. Cl. CPC G06Q 10/087; A47F 10/00; A47F 5/0018; A47F 5/01; B62B 3/005; G06K 7/10415; G06K 7/10356; G06K 7/10089; A47F 2010/005

(57) ABSTRACT

A wire cart has a plurality of shelving assemblies, each of which has an RFID antenna. The wire cart also has a controller that controls the RFID antennas and an actuator to activate the controller. The wire cart has an open side. The RFID antennas and control component are configured to limit the field of detection such that an RFID tag located substantially outside of the open side is excluded from detection.

### CROSS REFERENCE TO RELATED APPLICATIONS

[Not Applicable]

### FEDERALLY SPONSORED RESEARCH OR DEVELOPMENT

[Not Applicable]

### JOINT RESEARCH AGREEMENT

[Not Applicable]

### SEQUENCE LISTING

[Not Applicable]

### BACKGROUND

Generally, this application relates to radio-frequency identification (“RFID”) enabled shelving units (for example, mobile wire carts with RFID functionality).

Facilities such as hospitals may employ wire carts (for example, four-shelf wire carts) for stocking items such as lower-cost consumable items. Maintaining inventory is typically a labor intensive and time consuming process that requires staff members to constantly monitor stock/inventory levels.

One existing RFID-enabled shelving unit has locking doors and requires a badge for access. This unit also needs to be sealed to prevent RF signals from leaving the cabinet and reading product not physically located inside the cabinet.

### SUMMARY

According to certain inventive techniques of one or more embodiments of the present technology, a shelving unit (for example, a wire cart) with at least one open side having at least one shelving assembly (one or a plurality), at least one control component, and at least one wireless communication component is provided. The shelving assembly of the present technology has at least one shelf and at least one RFID antenna (which may be located above or on top of the shelf) that can scan a plurality of RFID tags (attached to items stored on the shelf). Thus, at least some shelving assembly embodiments of the present technology scan and receiving signals to and from the plurality of RFID tags. The shelving assembly may also include one or more shelf liners that conceal the upper side of the one or more RFID antennas. Further, at least one control component is electrically connected to the RFID antenna which causes the RFID antenna to transmit at least one signal. It should be appreciated that the one or more control component(s) can also receive information corresponding to the plurality of RFID tags from the RFID antenna.

Additionally, the at least one wireless communication component can receive information corresponding to the plurality of RFID tags from the at least one control component and can wirelessly communicate such information with at least one device located remotely from the shelving unit. The RFID antenna and the at least one control component are configured to limit at least one field of detection of the RFID antenna such that at least one RFID tag substantially outside of the open side of the shelving unit (for example, approximately 24 inches outside of the open side of the shelving unit) is excluded from detection by the RFID antenna and the at least one control component.

The shelving unit may also include at least one actuator that is actuated (for example, manually or by a timer or with a remote control, among others) and in communication with the at least one control component, wherein an actuation of the at least one actuator causes the at least one control component to cause the RFID antenna to transmit at least one signal. The shelving unit may also include at least one battery that provides electrical power to the at least one control component and the at least one wireless communication component. The shelving unit of the present technology may also include at least one visual indicator electrically connected with at least one of the at least one control component(s) and the at least one wireless communication component(s). The at least one visual indicator may visually display status of the at least one wireless communication component, charge level of the battery, whether the shelving unit is being powered by the battery, and/or whether the at least one control component is presently performing a scan, among other information. In some embodiments of the present technology, the left side, right side, and rear side of the shelving unit (for example, a wire cart) may have a wire mesh panel that limits the field of detection of the RFID antenna, but not the field of view of an observer interacting with the shelving unit.

According to certain inventive techniques of the present technology, a kit for installation on a mobile shelving unit is provided that can include a plurality of shelves and at least one open side. The kit also includes a plurality of radio-frequency identification (“RFID”) antennas for installation to a corresponding shelf of the plurality of shelves, wherein each of the plurality of RFID antennas is configured to scan a plurality of RFID tags attached to items stored on the corresponding shelf of the plurality of shelves by transmitting and receiving signals to and from the plurality of RFID tags.

The kit further includes at least one control component configured to be electrically connected to each of the plurality of RFID antennas and, once installed, configured to: cause each of the plurality of RFID antennas to transmit at least one signal; and receive information corresponding to the plurality of RFID tags from the plurality of RFID antennas. The kit also includes at least one wireless communication component configured to be in communication with the at least one control component, wherein the at least one wireless communication component, once installed, is configured to: receive the information corresponding to the plurality of RFID tags from the at least one control component; and wirelessly communicate the information corresponding to the plurality of RFID tags with a device located remotely from the mobile shelving unit. The plurality of RFID antennas and the at least one control component, once installed, are configured to limit at least one field of detection of each of the plurality of RFID antennas such that an RFID tag located substantially outside of the open side of the mobile shelving unit (for example, approximately 12 to 24 inches outside) is excluded from detection by the plurality of RFID antennas and the at least one control component.

The kit may also include at least one actuator configured to be actuated and, once installed, in communication with the at least one control component, wherein, once installed, an actuation of the at least one actuator causes the at least one control component to cause each of the plurality of RFID antennas to transmit at least one signal. Additionally, the kit may further include a plurality of shelf liners configured to be installed above the plurality of RFID antennas, wherein, once installed, the plurality of shelf liners conceal upper sides of each of the plurality RFID antennas. The kit may include at least one battery configured to provide electrical power to the control component and the wireless communication component once installed. Moreover, the kit may include at least one visual indicator configured to be electrically connected with at least one of the at least one control component and the at least one wireless communication component once installed, wherein, once installed, the at least one visual indicator is configured to display at least one of a status of the at least one wireless communication component, a charge level of the battery, whether the mobile shelving unit is being powered by the battery, and whether the at least one control component is performing a scan, among other information.

### BRIEF DESCRIPTION OF SEVERAL VIEWS OF THE DRAWINGS

FIG. 1 illustrates a shelving unit, according to certain inventive techniques.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings.

### DETAILED DESCRIPTION

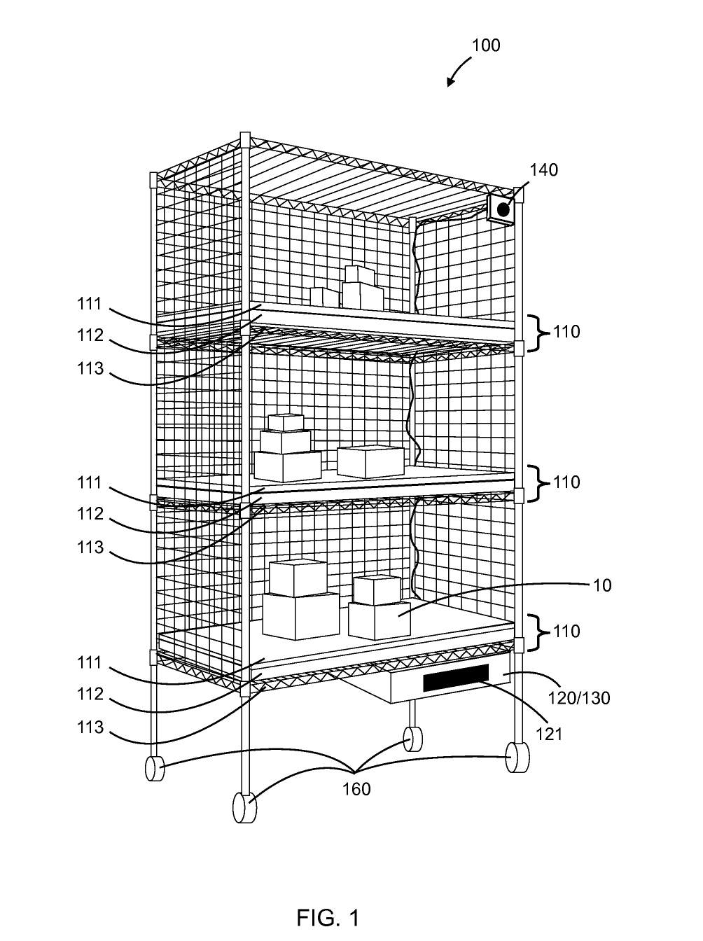

FIG. 1 illustrates a shelving unit 100, according to certain inventive techniques. The shelving unit 100 may have one or more open sides allowing for convenient access to items 10 stored therein. As depicted, the shelving unit 100 includes left, right, and rear panels, each of which includes a wire mesh. The top shelf or panel may also be wire mesh. Other materials for the panels include plastic or wood.

The shelving unit 100 may include one or more shelving assemblies 110, at least one control component 120, at least one wireless communication component 130, at least one actuator 140, and/or wheels 160. It should be understood that a control component 120 may include one or more control components that, taken together, perform one or more functions of a control component 120 as described herein. It should also be understood that a wireless communication component 130 may include one or more wireless communication components that, taken together, perform one or more functions of a wireless communication component 130 as described herein.

A shelving assembly 110 may support one or more items 10. The items 10 may be attached to one or more corresponding RFID tags that contain information corresponding to the tagged item 10. RFID tag data may include, for example, one or more of an EPC code, a TID code, a serial number, a product description, a date, and a lot number (among others). A shelving assembly 110 may include at least one shelf 113, at least one RFID antenna 112, or at least one shelf liner 111. The RFID antenna 112 may be located above or below the shelf 113. According to one technique of the present technology, the shelf liner 111 may be located on top of the RFID antenna 112 to conceal the upper side of the RFID antenna 112.

Each RFID antenna 112 may be configured to scan the RFID tags attached to the items 10 stored on the shelf. Scanning may occur by transmitting RF energy from the RFID antenna 112 and receiving responsive RF energy received back from the RFID tags at the RFID antenna 112. In some embodiments, an RFID antenna 112 may be arranged to project RFID energy upwardly (for example, towards items 10 resting on its particular shelving assembly 110) or downwardly (for example, towards items 10 resting on a shelving assembly 110 below the one in which it forms a part). An RFID antenna 112 may also be arranged to project RFID energy outwardly, for example, if the RFID antenna 112 is mounted on the back panel.

Each RFID antenna 112 may be electrically connected to the control component 120 (for example, by one or more coaxial RF cables. The control component 120 may transmit RF energy, which is in turn transmitted from a connected RFID antenna 112. The received signal (originally transmitted by the RFID tags, and which includes information stored in the RFID tags) at the RFID antenna 112 may then be communicated back to the control component 120 via the cables, where it is received.

The wireless communication component 130 may be in communication (for example, electrically connected) with the control component 120. The control component 120 and the wireless communications component 130 may be housed together as depicted, or may be located in separate locations on the shelving unit 100. The control component 120 and the wireless communications component 130 may be mounted proximate the bottom of the shelving unit 100 (for example, underneath the lowermost shelving assembly 110). The wireless communication component 130 may receive, from the control component 120, the information corresponding to the RFID tags. This information may then be wirelessly communicated by the wireless communications component 130 to at least one device located remotely from the shelving unit 100.

A given RFID antenna 112 and the control component 120 may be configured (e.g., tuned) to limit the field of detection of the RFID antenna 112 such that an RFID tag substantially outside of the open side of the shelving unit 100 (e.g., approximately 12 to 24 inches outside of the open side) is excluded from detection. For example, the active read zone for each RFID antenna 112 may be contained within a few feet from each RFID antenna 112 as to prevent one shelving unit 100 from reading any RFID tagged items located on an adjacent shelving unit 100. To help contain the RF signal emitted from the RFID antenna(s) 112, the sides and back of the shelving unit may include wire panels (for example, wire mesh) or screening. Such mesh or screening may not substantially limit the field of view of a user, while still providing RF signal containment functionality.

The shelving unit 100 may also include one or more actuators 140. One actuator 140 may be in communication with (for example, electrically connected to) the control component 120 and/or wireless communications component 130. By actuating the actuator 140 (for example, by a user pressing the actuator 140), the control component 120 may responsively initiate an RFID read cycle to detect the RFID tagged items on the shelving unit 100. The actuator 140 may have at least one indicator (for example, a lamp) that provides feedback to the user to indicate that the actuator 140 has been pressed and that a read cycle is taking place. Other types of feedback are possible, such as haptic feedback. The actuator 140 may cause the visual indicator 121 to illuminate and/or to display particular information described herein. A separate actuator may be provided to control the visual indicator 121. Other actuators (or the same actuator 140) may also be employed to control various other functions of the shelving unit 100, such as causing wireless transmission, resetting a clock (for example a circadian clock), powering the shelving unit 100 on/off, or the like. One or more actuator 140 may be manually actuated or automatically actuated. For example, an actuator may be controlled by an internal timer (for example, to cause periodic scanning of the RFID tags) or by at least one remote control unit, or through a wireless connection (such as WiFi, WiMax, Bluetooth®, among others).

The shelving unit 100 may also include at least one battery that provides electrical power to the power-drawing components (for example, the control component 120 and/or the wireless communications component 130). The battery may be rechargeable or replaceable. The shelving unit 100 may also be powered by other sources, such as AC power sources. Such other power sources may serve to recharge the battery as well when the shelving unit 100 is plugged in. The battery may be housed with the control component 120 or located in some other location of the shelving unit 100.

The shelving unit 100 may also include at least one visual indicator 121. The visual indicator 121 may be part of the control component 120, or may be located in some other location of the shelving unit 100 remote from the control component. It should be understood that the visual indicator 121 may include one or more further indicators that, taken together, perform one or more functions of a visual indicator 121 as described herein. The visual indicator 121 may be in communication with (for example, electrically connected to) the control component 120 and/or the wireless communications component 130. The visual indicator 121 may display at least one of a status of the wireless component 130, a charge level of the battery, whether the apparatus is being powered by the battery, or whether the control component 120 is performing a scan, system status, among other forms of information or activities.

Certain components may be provided as a kit for installation on to a shelving unit with at least one open side and a plurality of shelves that is not yet RFID enabled (for example, a standard four-shelf mobile wire cart). Such a kit may include a one or more RFID antennas 112 for installation to the corresponding one or more of shelves. Each RFID antenna 112 is configured to scan RFID tags attached to items 10 stored on the corresponding shelf by transmitting and receiving signals to and from the RFID tags. The kit further includes at least one control component 120 configured to be electrically connected to each RFID antenna and, once installed, configured to: cause each of RFID antenna to transmit at least one signal; and receive information corresponding to the RFID tags from each RFID antenna. The kit also includes at least one wireless communication component 130 configured to be in communication with the at least one control component (for example, electrically connected), wherein the at least one wireless communication component 130, once installed, is configured to: receive the information corresponding to the RFID tags from the at least one control component 130; and wirelessly communicate the information corresponding to the RFID tags with a device located remotely from the mobile shelving unit. Each RFID antenna 112 and the at least one control component 130, once installed, are configured (for example, tuned) to limit at least one field of detection of each RFID antenna 112 such that an RFID tag located substantially outside of the open side of the mobile shelving unit (for example approximately 24 inches outside) is excluded from detection by each RFID antenna 112 and the at least one control component 120. It should be appreciated by those skilled in the art that where various measurements are provided in inches that are other measurements are also envisaged such as corresponding or complimentary metric measurements.

The kit may also include at least one actuator 140 configured to be automatically or manually actuated and, once installed, in communication with the at least one control component 120, wherein, once installed, an actuation (for example, manual actuation) of the at least one actuator 140 causes the at least one control component 120 to cause each RFID antenna 112 to transmit at least one signal. The kit may further include one or more shelf liners 11 configured to be installed above each RFID antenna 112, wherein, once installed, each shelf liner 111 conceals an upper side of a corresponding RFID antenna 112. The kit may also include a battery configured to provide electrical power to the at least one control component 120 and the at least one wireless communication component 130 once installed. Moreover, the kit may include at least one visual indicator 121 configured to be electrically connected with at least one of the at least one control component 120 and the at least one wireless communication component 130 once installed, wherein, once installed, the at least one visual indicator 121 is configured to visually display at least one of a status of the at least one wireless communication component 130, a charge level of the battery, whether the mobile shelving unit is being powered by the battery, and whether the at least one control component 120 is presently performing a scan.

To stock/restock the inventory, a user may apply one or more RFID tags to items 10. These tags will then be associated to each specific item 10. Then the items 10 may be placed in the shelving unit 100 and consumed as needed. When stock level of a given type of item 10 drops below a threshold, then an auto-replenishment process may be triggered.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A shelving unit including at least one open side, wherein the shelving unit comprises:
a shelving assembly, wherein the shelving assembly includes:
at least one shelf;
at least one radio-frequency identification (“RFID”) antenna, wherein the RFID antenna is configured to scan a plurality of RFID tags attached to items stored on the at least one shelf by transmitting and receiving signals to and from the plurality of RFID tags;
at least one control component electrically connected to the RFID antenna and configured to:
cause the at least one RFID antenna to transmit at least one signal; and
receive information corresponding to the plurality of RFID tags from the at least one RFID antenna; and
at least one wireless communication component in communication with the at least one control component, wherein the at least one wireless communication component is configured to:
receive the information corresponding to the plurality of RFID tags from the at least one control component; and
wirelessly communicate the information corresponding to the plurality of RFID tags with a device located remotely from the shelving unit,
wherein the at least one RFID antenna and the at least one control component are configured to limit at least one field of detection of the at least one RFID antenna such that an RFID tag substantially outside of the open side of the shelving unit is excluded from detection by the at least one RFID antenna and the at least one control component.

2. The shelving unit of claim 1, wherein the at least one control component and the at least one RFID antenna are configured to limit at least one field of detection of the at least one RFID antenna such that an RFID tag located approximately 24 inches outside of the open side of the shelving unit is excluded from detection by the at least one RFID antenna and the at least one control component.

3. The shelving unit of claim 1, further comprising at least one actuator configured to be actuated and in communication with the at least one control component, wherein an actuation of the at least one actuator causes the at least one control component to cause the at least one RFID antenna to transmit a signal.

4. The shelving unit of claim 1, wherein:
the at least one RFID antenna is located above the at least one shelf in the shelving assembly; and
the shelving assembly includes at least one shelf liner above the at least one RFID antenna, wherein the at least one shelf liner conceals an upper side of the at least one RFID antenna.

5. The shelving unit of claim 1, further comprising a battery configured to provide electrical power to the at least one control component and the at least one wireless communication component.

6. The shelving unit of claim 5, further comprising at least one visual indicator electrically connected with at least one of the at least one control component and the at least one wireless communication component, wherein the at least one visual indicator is configured to visually display at least one of a status of the at least one wireless communication component, a charge level of the battery, whether the shelving unit is being powered by the battery, and whether the at least one control component is presently performing a scan.

7. The shelving unit of claim 1, wherein the shelving unit comprises a wire cart.

8. The shelving unit of claim 7, wherein a left side, a right side, and a rear side of the wire cart each comprise at least one wire mesh panel configured to limit the field of detection of the RFID antenna, but not the field of view.

9. A shelving unit including at least one open side, wherein the shelving unit comprises:
a plurality of shelving assemblies, wherein each of the plurality of shelving assemblies includes:
at least one shelf;
at least one radio-frequency identification (“RFID”) antenna, wherein the at least one RFID antenna is configured to scan a plurality of RFID tags attached to items stored on the at least one shelf by transmitting and receiving signals to and from the plurality of RFID tags;
at least one control component electrically connected to each of the plurality of at least one RFID antennas and configured to:
cause each of the plurality of at least one RFID antennas to transmit at least one signal; and
receive information corresponding to the plurality of RFID tags from the plurality of at least one RFID antennas; and
at least one wireless communication component in communication with the at least one control component, wherein the at least one wireless communication component is configured to:
receive the information corresponding to the plurality of RFID tags from the at least one control component; and
wirelessly communicate the information corresponding to the plurality of RFID tags with a device located remotely from the shelving unit,
wherein the plurality of at least one RFID antennas and the at least one control component are configured to limit a field of detection of each of the plurality of at least one RFID antennas such that an RFID tag located substantially outside of the open side of the shelving unit is excluded from detection by the plurality of at least one RFID antennas and the at least one control component.

10. The shelving unit of claim 9, wherein the at least one control component and the plurality of at least one RFID antennas are configured to limit a field of detection of each of the plurality of at least one RFID antennas such that an RFID tag located approximately 24 inches outside of the open side of the shelving unit is excluded from detection by the plurality of at least one RFID antennas and the at least one control component.

11. The shelving unit of claim 9, further comprising at least one actuator configured to be actuated and in communication with the at least one control component, wherein a manual actuation of the at least one actuator causes the at least one control component to cause each of the plurality of at least one RFID antennas to transmit at least one signal.

12. The shelving unit of claim 9, wherein:
the at least one RFID antenna is located above the at least one shelf in each of the plurality of shelving assemblies; and
each of the plurality of shelving assemblies includes at least one shelf liner above the at least one RFID antenna, wherein the at least one shelf liner conceals an upper side of the RFID antenna.

13. The shelving unit of claim 9, further comprising a battery configured to provide electrical power to the at least one control component and the at least one wireless communication component.

14. The shelving unit of claim 13, further comprising at least one visual indicator electrically connected with at least one of the at least one control component and the at least one wireless communication component, wherein the at least one visual indicator is configured to display at least one of a status of the at least one wireless communication component, a charge level of the battery, whether the shelving unit is being powered by the battery, and whether the at least one control component is presently performing a scan.

15. The shelving unit of claim 9, wherein the shelving unit comprises a wire cart.

16. The shelving unit of claim 15, wherein a left side, a right side, and a rear side of the wire cart each comprise a panel configured to limit the field of detection of the plurality of RFID antennas.

17. A kit for installation on a mobile shelving unit, wherein the mobile shelving unit includes a plurality of shelves and at least one open side, and wherein the kit comprises:
a plurality of radio-frequency identification (“RFID”) antennas for installation to a corresponding shelf of the plurality of shelves, wherein each of the plurality of RFID antennas is configured to scan a plurality of RFID tags attached to items stored on the corresponding shelf of the plurality of shelves by transmitting and receiving signals to and from the plurality of RFID tags;
at least one control component configured to be electrically connected to each of the plurality of RFID antennas and, once installed, configured to:
cause each of the plurality of RFID antennas to transmit at least one signal; and
receive information corresponding to the plurality of RFID tags from the plurality of RFID antennas; and
at least one wireless communication component configured to be in communication with the at least one control component, wherein the at least one wireless communication component, once installed, is configured to:
receive the information corresponding to the plurality of RFID tags from the at least one control component; and
wirelessly communicate the information corresponding to the plurality of RFID tags with a device located remotely from the mobile shelving unit,
wherein the plurality of RFID antennas and the at least one control component, once installed, are configured to limit at least one field of detection of each of the plurality of RFID antennas such that an RFID tag located substantially outside of the open side of the mobile shelving unit is excluded from detection by the plurality of RFID antennas and the at least one control component.

18. The kit of claim 17, wherein the at least one control component and the plurality of RFID antennas are configured to limit at least one field of detection of each of the plurality of RFID antennas such that an RFID tag located approximately 24 inches outside of the open side of the mobile shelving unit is excluded from detection by the plurality of RFID antennas and the at least one control component.

19. The kit of claim 17, further comprising at least one actuator configured to be manually activated and, once installed, in communication with the at least one control component, wherein, once installed, a manual actuation of the at least one actuator causes the at least one control component to cause each of the plurality of RFID antennas to transmit at least one signal.

20. The kit of claim 17, further comprising a plurality of shelf liners configured to be installed above the plurality of RFID antennas, wherein, once installed, the plurality of shelf liners conceal upper sides of each of the plurality RFID antennas.

21. The kit of claim 17, further comprising a battery configured to provide electrical power to the at least one control component and the at least one wireless communication component once installed.

22. The kit of claim 21, further comprising at least one visual indicator configured to be electrically connected with at least one of the at least one control component and the at least one wireless communication component once installed, wherein, once installed, the at least one visual indicator is configured to display at least one of a status of the at least one wireless communication component, a charge level of the battery, whether the mobile shelving unit is being powered by the battery, and whether the at least one control component is presently performing a scan.
